(19) United States
(12) Patent Application Publication
(10) Pub. No.: US 2005/0008867 A1
(43) Pub. Date: Jan. 13, 2005

(54) Method of manufacturing structures and structures resulting there from

(76) Inventor: David Knower LaBatt, Albany, NY (US)

Correspondence Address: John W. LaBatt, 26 Robinwood Lane, Valatie, NY, 12184, US

(21) Appl. No.: 10/886,346

(22) Filed: Jul. 7, 2004

Related U.S. Application Data
(60) Provisional application No. 60/485,214, filed on Jul. 7, 2003.

(51) Int. Cl. C08F 8/00

(52) U.S. Cl. 428/413; 264/219; 264/338; 525/107

(57) ABSTRACT

A method of manufacturing a structure by forming an element of the structure using a mold. Resin is poured into the mold to form the element. The element can further incorporate any number of a variety of solids. The element may then be assembled with one or more additional elements to complete the structure.

### RELATED APPLICATION

The current application claims the benefit of co-pending U.S. Provisional Application No. 60/485,214, filed on Jul. 7, 2003, which is hereby incorporated herein by reference.

### BACKGROUND OF THE INVENTION

1. Field of Invention

The invention relates to furniture and three-dimensional art (“structures”), and more particularly to a method of making these structures.

2. Related Art

Conventionally, furniture and three-dimensional art (“structures”) are manufactured using various combinations of well known materials (e.g., wood, polished glass, metal, etc.) that are assembled using well known construction techniques. While these materials and techniques provide a traditional look and/or feel for the resulting structure, many individuals desire structures having a more unique look and/or feel. One way to obtain a unique look and/or texture for a structure is through the use of other nontraditional material. Thus, a need exists for a new method of manufacturing that allows various materials to be used in the creation of a structure to create a unique look and/or a unique texture for the structure.

### SUMMARY OF THE INVENTION

The invention provides a method of making structures wherein the materials used and looks achieved can vary widely from the conventional methods and looks. In particular, a mold can be created to create an element of the structure having a desired shape. Resin and/or other materials can be poured into the mold and allowed to harden. Subsequently, the element can be combined with one or more additional elements to form the structure. In one embodiment, an interior of the mold is lined with a sheet that allows the element to be readily removed and easy reuse of the mold for a subsequent element. Further, a release agent can be applied to the sheet and/or mold to further assist in removing the element. As a result, the invention provides a solution for making a non-traditional structure that has a unique look in a manner that allows a shape of one or more elements of the structure to be reused for other elements for the same or numerous structures.

A first aspect of the invention comprises a method of constructing an element of a structure, the method comprising: creating a mold having a desired shape of the element; lining an interior of the mold with a sheet; and pouring resin into the mold to create the element.

A second aspect of the invention comprises a method of constructing a structure, the method comprising: creating a mold having a desired shape of at least one element of the structure; lining an interior of the mold with a sheet; applying a release agent to the sheet; pouring resin into the mold to create the at least one element; and removing the at least one element from the mold after the resin has hardened.

A third aspect of the invention comprises a structure comprising at least one structural support element comprising resin and at least one solid deposited therein.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative mold for creating an element of a structure;

FIG. 2 shows an illustrative table;

FIG. 3 shows an illustrative clock; and

FIG. 4 shows illustrative method steps for creating an element of a structure.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As described above, the invention provides a method of making structures wherein the materials used and looks achieved can vary widely from the conventional methods and looks. In particular, a mold can be created to create an element of the structure having a desired shape. Resin and/or other materials can be poured into the mold and allowed to harden. Subsequently, the element can be combined with one or more additional elements to form the structure. In one embodiment, an interior of the mold is lined with a sheet that allows the element to be readily removed and easy reuse of the mold for a subsequent element. Further, a release agent can be applied to the sheet and/or mold to further assist in removing the element. As a result, the invention provides a solution for making a non-traditional structure that has a unique look in a manner that allows a shape of one or more elements of the structure to be reused for other elements for the same or numerous structures.

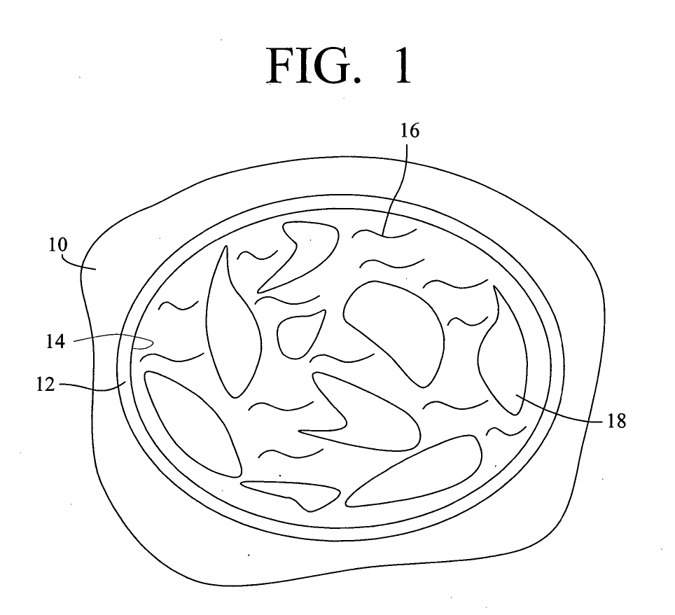

Turning to the Figures, FIG. 1 shows an illustrative mold 10 for creating an element of a structure according to one embodiment of the invention. As used herein, the term “structure” is used to refer to any three-dimensional work, including a sculpture, furniture such as a table, shelf, chair, etc., and accent furniture such as a clock, frame, light, etc. Further, the term “element” is used to refer to any part that forms the structure. For example, a table would typically include elements comprising four legs and a top.

In general, mold 10 can comprise any combination of various traditional manufacturing elements such as cardboard, wood, clay, plaster, tape, etc. Further, mold 10 can be created to form an element having any desired shape. To this extent, mold 10 can be used to form an element having a substantially longer length than width/depth (e.g., a leg for a table), an element having a small depth but relatively large width/length (e.g., a side for a mantel clock), etc. In the latter case, one side of the element can be uncovered by mold 10. As will be discussed further below, this configuration can generate an element having one side with that is uniquely textured.

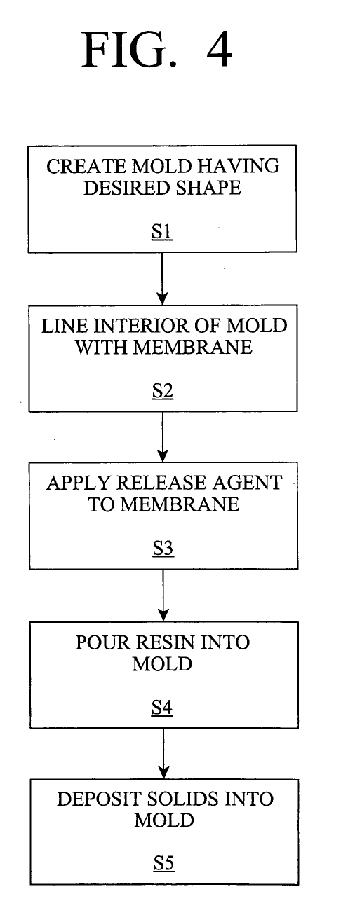

Additional details of FIG. 1 are discussed in conjunction with FIG. 4, which shows illustrative method steps for creating an element using mold 10. In step S1 of FIG. 4, mold 10 is created, which has a desired shape of the element to be constructed using mold 10. In step S2, an interior of mold 10 can be lined with a sheet 12. Sheet 12 can be used to ease in the removal of the element from mold 10. To this extent, sheet 12 can comprise any type of flexible sheet that can substantially conform to the shape of the element (interior of mold 10). For example, sheet 12 can comprise a thin sheet of plastic (e.g., plastic wrap) or a thin flexible sheet of metal (e.g., aluminum foil).

In step S3, a release agent 14 can be applied to sheet 12. Release agent 14 can assist in removing a finished element from mold 10 and sheet 12. To this extent, it is understood that release agent 14 should be present on a side of sheet 12 facing toward the interior of mold 10. In one embodiment, release agent 14 can be applied to sheet 12 prior to step S2, and sheet 12 is placed in the interior of mold 10 so that release agent 14 is appropriately located. Alternatively, release agent 14 can be applied directly to mold 10. Further, release agent 14 could be used instead of sheet 12. Still further, sheet 12 could be permanently or temporarily attached to mold 10. In any event, release agent 14 can comprise any type of compound that will assist in removing the finished element from mold 10 and/or sheet 12. For example, release agent 14 could comprise a mold release typically used in candle making.

In step S4, resin 16 is poured into mold 10. Resin 16 can comprise any type of resin that comprises a liquid form when obtained, but will harden once exposed to air and/or heat. To this extent, resin is typically used as a general surface coating for a table top or the like. In one embodiment, resin 16 comprises a two-part epoxy resin substantially comprising of a resin and a hardener. Further, resin 16 can comprise a dye resin or the like. In any event, resin 16 is poured into mold 10 and allowed to harden to form the element. As a result, resin is used to create the element, rather than merely coating a surface of the element.

In step S5, one or more solids 18 can be deposited into mold 10. Solid(s) 18 can be deposited after pouring resin 16 and prior to its hardening and/or prior to pouring resin 16 into mold 10. In either case, resin 16 hardens around all or a portion of solids 18 to create the element. Each solid 18 can comprise any material, size and/or shape to obtain a desired appearance of the element. However, in one embodiment of the invention no solid 18 individually provides support and/or shape for the element without the hardened resin 16. For example, solid(s) 18 can comprise broken glass, pottery, stone, plastic, sand, a mirror, wire, porcelain, etc. Further, solid(s) 18 can comprise plant and/or animal materials such as wood, leaves, fruit, vegetables, etc.

Once resin 16 has hardened, the element can be removed from mold 10. For example, sheet 12 and resin 16 can be removed, and sheet 12 can be removed from resin 16. As noted above, release agent 14 can further assist in the removal of the element so that mold 10 is not damaged and can be used to create another element. One or more additional steps also may be required. For example, due to the way resin 16 hardens, it may be necessary to remove excess resin from the element. In any event, the element can then be used to construct a structure that includes a plurality of elements.

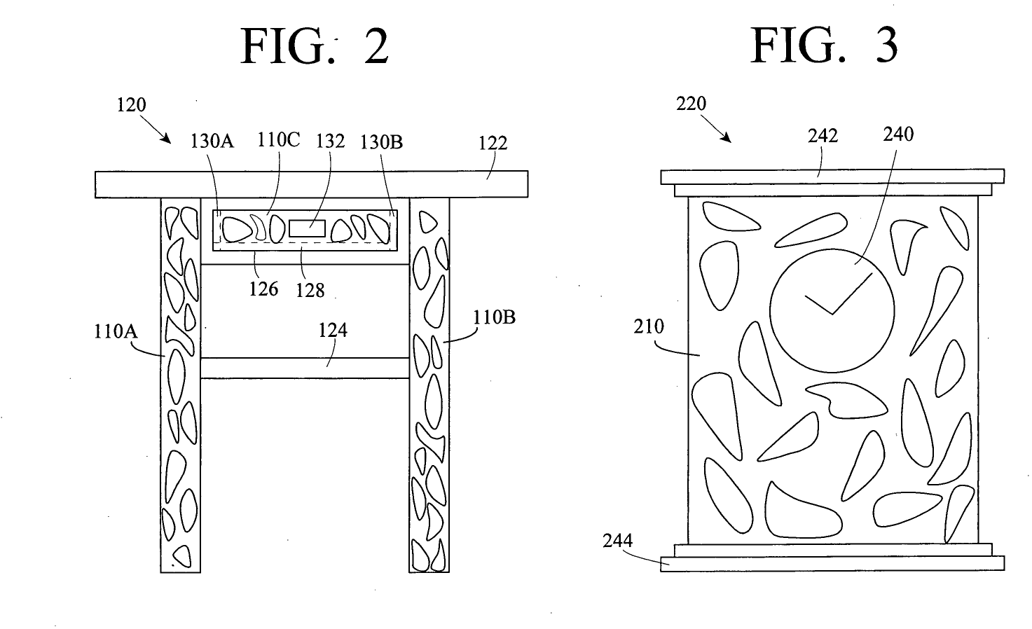

FIGS. 2 and 3 show illustrative structures 120, 220, respectively. Structures 120, 220 are formed by assembling elements 110A-C, 210 to one or more additional elements. For example, as shown in FIG. 2, elements 110A-B can provide structural support for structure 120. In this case, elements 110A-B comprise legs for structure 120. To this extent, it is understood that one or more traditional structural support elements can be included in elements 110A-B to provide additional support for structure 120. For example, one or more of elements 110A-B could have a metallic rod or the like disposed within resin 16 (FIG. 1) and along the length of element 11A-B to provide support for structure 120 when disposed in an upright position. However, it is understood that element 110A-B will comprise a large portion of resin 16 (FIG. 1) and/or solids 18 (FIG. 1) that substantially define the overall look and/or shape of element 110A-B.

Structure 120 can also include one or more elements that comprise traditional building materials such as wood, marble, polished glass, and the like that are formed using traditional building techniques. For example, a top 122 and/or a lower support/shelf 124 of structure 120 can comprise glass. Further, other materials can be incorporated into structure 120 to add support. For example, top surface 122 could comprise a thermoplastic acrylic resin, a light weather resistant thermoplastic, a polycarbonate, or the like, alone or in combination with resin 16 (FIG. 1). Still further, top 122 and shelf 124 could both comprise resin 16 and be constructed as described above. To this extent, structure 110 can comprise a plurality of resin 16 and/or solid 18 (FIG. 1) elements joined to other resin 16 and/or solid 18 elements.

Additionally, a structure can include other functional elements. For example, structure 120 is shown including a drawer 126. Drawer 126 comprises an element 110C for a facing side of drawer 126. In one embodiment, drawer 126 can comprise a bottom 128 and one or more sides 130A-B comprising a smooth material such as a thermoplastic acrylic resin, a light weather resistant thermoplastic, a polycarbonate, polished glass, wood, etc. To construct element 110C, mold 10 (FIG. 1) can comprise a relatively narrow depth compared to the width and length. Further, a top of mold 10 can remain exposed. As a result, when one or more solids 18 (FIG. 1) are used in element 110C, portions of the solids 18 may protrude from the hardened resin 16 (FIG. 1).

Further, other solids can be disposed in mold 10 to provide functionality desired for element 110C. For example, a handle 132 can be placed in a desired position in element 110C. Various other functional solids, such as mechanical elements, can be incorporated into an element. For example, FIG. 3 shows an illustrative structure 220 that comprises a clock 240. Element 210 comprises a facing side of structure 220 and can comprise a structural support for structure 220. Clock 240 can be placed in resin 16 (FIG. 1) or be attached to element 210 after resin 16 has hardened using a traditional assembling technique as is known. It is understood that drawer 126 (FIG. 2) and clock 240 are only illustrative. To this extent, structures 120, 220 can include various other functional elements. For example, a door can be disposed on a back side of structure 220 to allow access to a back of clock 240. In this case, hinges and the like can be used to attach the door to structure 220. Further, felt or the like can be applied to the bottom of the structure to prevent scratching.

A top 242 and/or a bottom 244 of structure 220 can comprise elements made as described herein or made of traditional building material using a traditional manufacturing technique. In the former case, mold 10 (FIG. 1) can comprise a shape that forms a groove or the like in order to assist in attaching the elements to form structure 220. Alternatively, the required shape can be removed from and/or added to the element after resin 16 (FIG. 1) has hardened. Still further, traditional attaching approaches such as nails, screws, glue, etc., can be used to attach the elements.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of constructing an element of a structure, the method comprising:
creating a mold having a desired shape of the element;
lining an interior of the mold with a sheet; and
pouring resin into the mold to create the element.

2. The method of claim 1, wherein the sheet comprises at least one of a sheet of plastic and a sheet of metal.

3. The method of claim 1, further comprising depositing at least one solid into the mold.

4. The method of claim 3, further comprising removing excess resin from the element after the resin has hardened.

5. The method of claim 1, further comprising removing the element from the mold after the resin has hardened.

6. The method of claim 1, further comprising applying a release agent to the sheet prior to the pouring step.

7. A method of constructing a structure, the method comprising:
creating a mold having a desired shape of at least one element of the structure;
lining an interior of the mold with a sheet;
applying a release agent to the sheet;
pouring resin into the mold to create the at least one element; and
removing the at least one element from the mold after the resin has hardened.

8. The method of claim 7, further comprising assembling the at least one element with at least one other element to form the structure.

9. The method of claim 8, wherein the at least one other element comprises resin.

10. The method of claim 8, wherein the at least one other element comprises at least one of a thermoplastic acrylic resin, a light weather resistant thermoplastic, a polycarbonate, glass, and wood.

11. The method of claim 7, further comprising depositing at least one solid into the mold.

12. The method of claim 7, wherein the element comprises a structural support element of the structure.

13. The method of claim 7, wherein the element comprises a facing side of the structure.

14. A structure comprising at least one structural support element comprising resin and at least one solid deposited therein.

15. The structure of claim 14, further comprising a mechanical element.

16. The structure of claim 14, further comprising a drawer, wherein the drawer comprises:
a bottom comprising at least one of a thermoplastic acrylic resin, a light weather resistant thermoplastic, a polycarbonate, glass, and wood; and
a facing side comprising resin.

17. The structure of claim 14, further comprising at least one traditional structural support element comprising at least one of: wood, plastic, glass, and metal.

18. The structure of claim 17, wherein the resin comprises a two part epoxy resin substantially comprising of a resin and a hardener.

19. The structure of claim 14, wherein each of a plurality of elements of the structure comprises resin and at least one solid.

20. The structure of claim 14, further comprising a second element comprising resin, wherein the second element comprises a facing side of the structure.
